(19) United States
(12) Patent Application Publication
(10) Pub. No.: US 2012/0261493 A1
(43) Pub. Date: Oct. 18, 2012

(54) Atomizing nozzle structure

(76) Inventor: Hui Ting Hsu, Taichung City (TW)

(21) Appl. No.: 13/066,430

(22) Filed: Apr. 14, 2011

(51) Int. Cl. B05B 1/02; B05B 15/00; B05B 17/00

(52) U.S. Cl. 239/383; 239/570

(57) ABSTRACT

An atomizing nozzle structure includes a body, a cover, a rotor and a leak-stop assembly. The body has one axial end being an inlet, the other axial end being an outlet, and a channel connecting the inlet to the outlet. The cover is disposed on the outlet of the body. The rotor is movably accommodated within the channel of the body. The leak-stop assembly is composed of a spring and a plug and disposed in the channel. One surface of the rotor has a locking structure for prohibiting the spring from parting from the rotor in a state where the leak-stop assembly is combined with the rotor. When the elements are separated from one another, the rotor and the leak-stop assembly may be taken out of the channel of the body.

### BACKGROUND OF THE INVENTION

1. Field of the Invention

The invention relates to the technological field of a micro-atomizing device, and more particularly to an atomizing nozzle capable of atomizing water or a liquid similar to the water and spraying the water or liquid in an atomized state.

2. Related Art

A typical spraying system or device may be disposed at an outlet end of an atomizing nozzle. When the water or liquid flows through the atomizing nozzle, the water or liquid may be sprayed in an atomized manner using a rotor disposed in a body of the atomizing nozzle and a water jet of the outlet end with a small aperture.

When the spraying system does not work, a little water or liquid is remained in the conduit of the spraying system. In order to prevent the water or liquid in the conduit from flowing out of the atomizing nozzle, a leak-stop assembly may be disposed in the body of the atomizing nozzle. The leak-stop assembly is composed of a spring and a plug, and the spring is combined with the rotor.

Because some fine particles or powder may be remained when the water or liquid flows through the atomizing nozzle, the normal working state of the atomizing nozzle is thus affected. Therefore, after the atomizing nozzle is used for a period of time, the atomizing nozzle has to be removed and decomposed into various elements, so that the obstructions may be cleaned conveniently.

However, only one end of the rotor is axially inserted into the spring of the leak-stop assembly, the condition that the rotor is taken out while the spring and the plug are still remained in the body tends to occur when the elements are decomposed. Consequently, an additional tool has to be used to take the spring and the plug out, and the process of decomposing the atomizing nozzle becomes inconvenient.

### SUMMARY OF THE INVENTION

It is therefore a main object of the invention to provide an atomizing nozzle structure, which can be easily decomposed into various elements and can be cleaned conveniently.

To achieve the above-mentioned object and effect, the invention provides an atomizing nozzle structure including a body, a cover, a rotor and a leak-stop assembly. The body has one axial end being an inlet, the other axial end being an outlet, and a channel connecting the inlet to the outlet. The cover is disposed on the outlet of the body. The rotor is movably accommodated within the channel of the body. The leak-stop assembly is composed of a spring and a plug, disposed in the channel and disposed between the rotor and the inlet. One surface of the rotor has a locking structure for prohibiting the spring from parting from the rotor in a state where the leak-stop assembly is combined with the rotor.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an exploded view showing a first embodiment of the invention.

FIG. 2 is an exploded view showing a second embodiment of the invention.

FIG. 3 shows the exterior of a rotor according to the first embodiment of the invention.

FIG. 4 shows the exterior of a rotor according to the second embodiment of the invention.

FIGS. 5 and 6 show exteriors of other rotors according to the first embodiment of the invention.

FIG. 7 is a schematically assembled view showing the invention.

FIG. 8 is a schematically exploded view showing various elements of the invention.

### DETAILED DESCRIPTION OF THE INVENTION

The present invention will be apparent from the following detailed description, which proceeds with reference to the accompanying drawings, wherein the same references relate to the same elements.

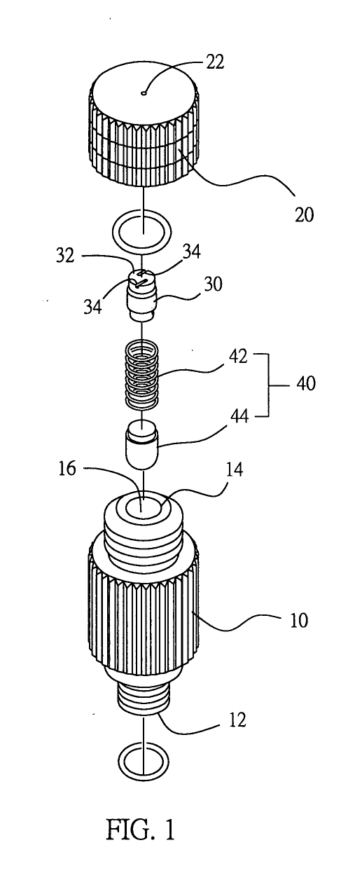

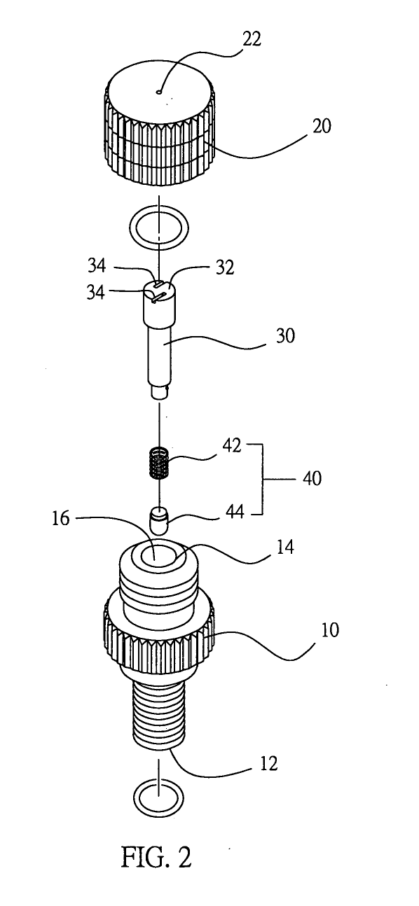

Referring to FIGS. 1 and 2, an atomizing nozzle includes a body (10), a cover (20), a rotor (30) and a leak-stop assembly (40). The difference between FIGS. 1 and 2 only resides in the shapes or dimensions of the corresponding elements.

More specifically, one axial end of the body (10) is an inlet (12), the other axial end is an outlet (14), and a channel (16) is formed to connect the inlet (12) with the outlet (14) in the axial direction of the body (10).

The cover (20) is disposed on one end of the body (10) and corresponds to the outlet (14). A water jetting hole (22), communicating with the outlet (14), is formed on the cover (20). In addition, the cover (20) may be combined with the body (10) by one of various means, such as screwing.

The rotor (30) is movably accommodated within the channel (16) of the body (10). A first end (32) of the rotor (30) is formed with a slot (34). The leak-stop assembly (40) is composed of a spring (42) and a plug (44). The leak-stop assembly (40) is accommodated within the channel (16) and disposed between the rotor (30) and the inlet (12).

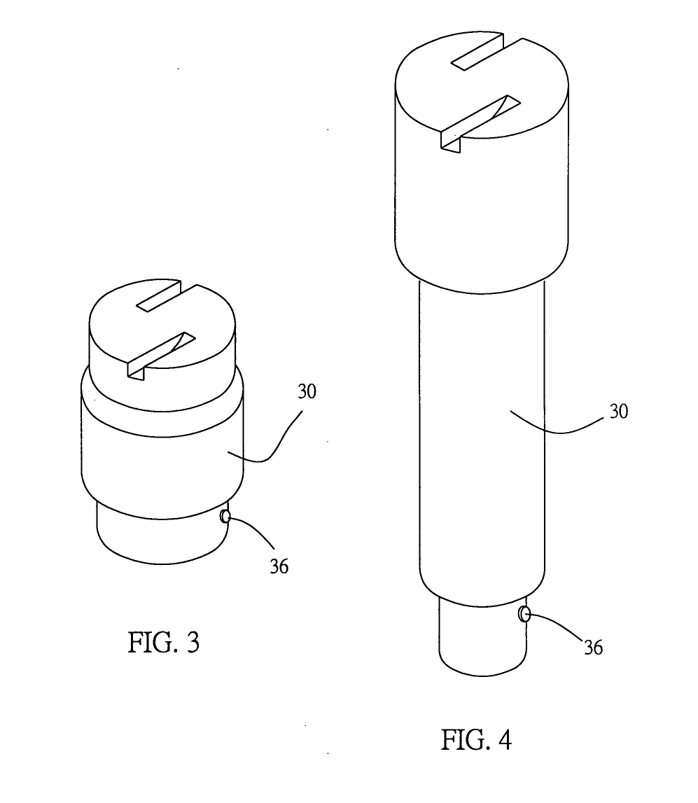

Referring to FIGS. 3 and 4, one surface of the rotor (30) is formed with a locking structure (36), which is a projection shown in the drawings.

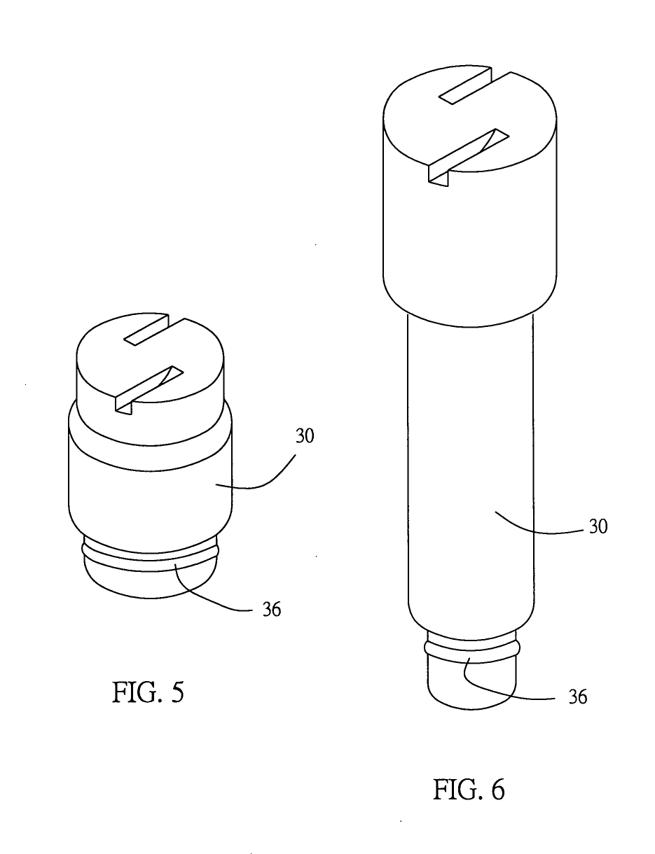

As shown in FIGS. 5 and 6, the locking structure (36) formed on the surface of the rotor (30) may be a flange.

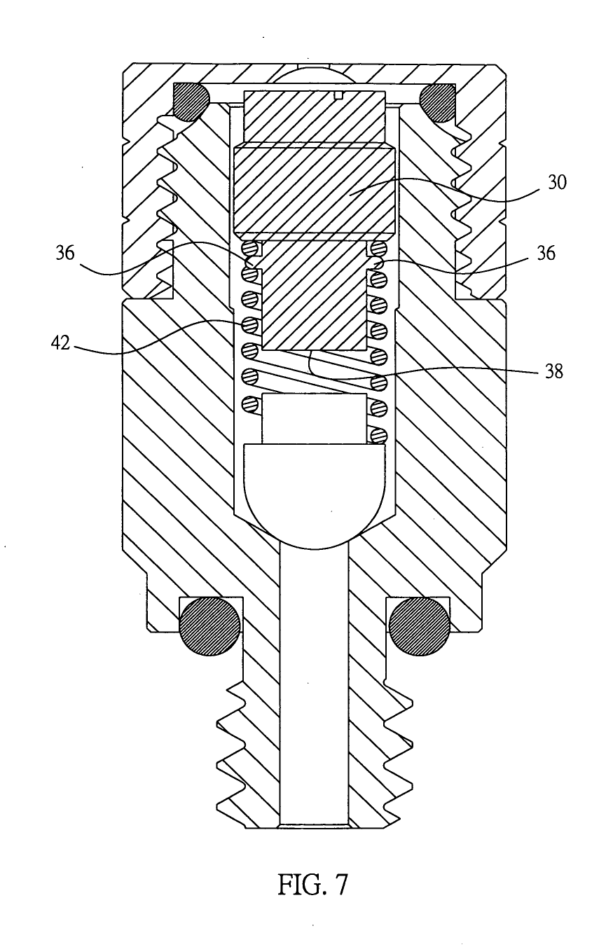

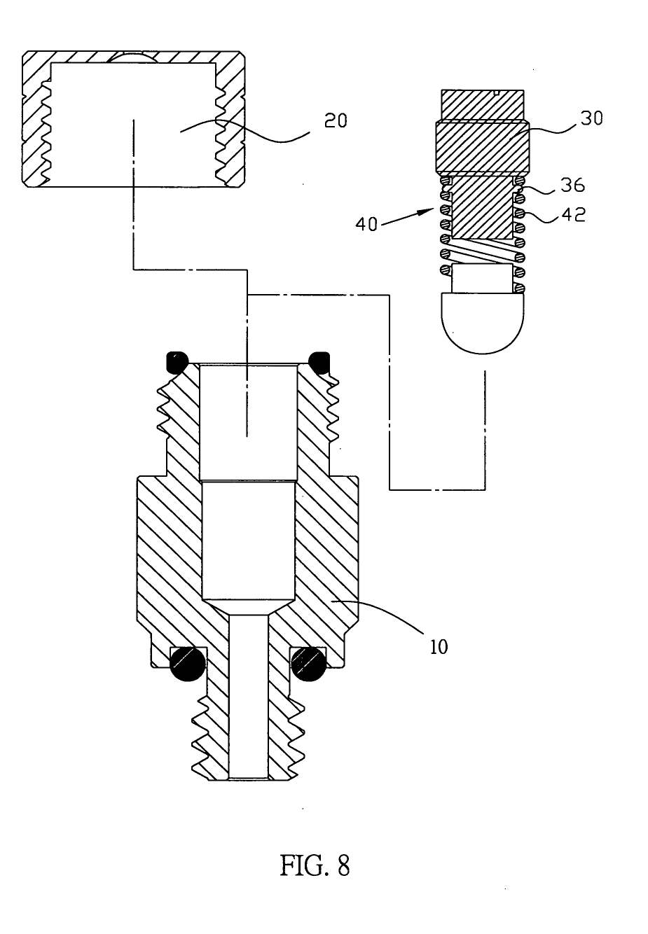

FIG. 7 shows the positions and the assembled state of the elements, wherein a second end (38) of the rotor (30) is axially inserted into the spring (42), and the locking structure (36) and the spring (42) form the combined state.

As shown in FIG. 8, after the user removes the cover (20) from the body (10), the rotor (30) may be removed from the body (10). At this time, the locking structure (36) of the rotor (30) is combined with the spring (42), so the overall leak-stop assembly (40) together with the rotor (30) may be taken out concurrently.

Next, the user exerts an acting force on the rotor (30) and/or the spring (42), and the spring (42) may be separated from the locking structure (36) of the rotor (30) according to the deformable property of the spring (42).

The leak-stop assembly (40) and the rotor (30) are taken out of the body (10) concurrently and the rotor (30) may be separated from the spring (42) by slightly pulling the rotor (30) and/or the spring (42). So, the operation is very simple and laborsaving. In addition, in the state where the elements are separated from one another, the user can clean the elements conveniently.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle structure, comprising:
a body having one axial end being an inlet, the other axial end being an outlet, and a channel connecting the inlet to the outlet;
a cover disposed on the outlet of the body;
a rotor movably accommodated within the channel of the body; and
a leak-stop assembly, which is composed of a spring and a plug, disposed in the channel and disposed between the rotor and the inlet,
wherein one surface of the rotor has a locking structure for prohibiting the spring from parting from the rotor in a state where the leak-stop assembly is combined with the rotor.

2. The atomizing nozzle structure according to claim 1, wherein the locking structure is a projection.

3. The atomizing nozzle structure according to claim 1, wherein the locking structure is a flange.

4. The atomizing nozzle structure according to claim 1, wherein the cover has a water jetting hole.
